(19) United States
(12) Patent Application Publication
(10) Pub. No.: US 2015/0168061 A1
(43) Pub. Date: Jun. 18, 2015

(54) METHOD AND APPARATUS FOR DEHUMIDIFICATION OF GENERATOR WINDING INSULATION

(71) Applicant: Ogin, Inc., Waltham, MA (US)

(72) Inventors: Ove Styhm Kristensen, Hadsten (DK); Rasmus Peter Jensen, Gjern (DK)

(21) Appl. No.: 14/575,652

(22) Filed: Dec. 18, 2014

Related U.S. Application Data
(60) Provisional application No. 61/917,730, filed on Dec. 18, 2013.

(51) Int. Cl. F26B 3/353; F26B 23/06

(52) U.S. Cl. CPC F26B 3/353; F26B 23/06

(57) ABSTRACT

The present disclosure relates to electrical generators, more specifically to an apparatus and method for dehumidifying the windings and insulation system of a generator. The application of low-voltage, low-frequency, high-AC-current provides precise control of the rise of temperature in the winding. The controlled temperature increase occurs uniformly over the complete length of the winding, providing uniform dehumidification of the insulation system such that connection to the inverter and power production occurs without risk of damage to the insulation system.

### CROSS-REFERENCE TO RELATED APPLICATIONS

This application claims priority to and benefit of U.S. Provisional Patent Application No. 61/917,730, filed Dec. 18, 2013, the disclosure of which is incorporated herein by reference in its entirety.

### BACKGROUND

Embodiments of the disclosure relate generally to electric motors and generators, and more particularly to systems and methods for dehumidifying the windings and insulation system of electric motors and generators.

High-voltage systems designed to handle the flow of maximum rated power can undergo stress during initial start or during a start after a dormant period. Various situations can cause moisture to become deposited in the insulation proximal to the windings of an electrical machine. For example, during transportation from a manufacturing facility to an installation site, or during a dormant period in a humid environment, an electrical machine is subjected to ambient humidity. Protective covers are often employed; however, sufficient exposure time and/or humidity levels tend to cause humidity to penetrate an electrical machine enclosure and influence the winding insulation system. Humidity in the insulation surrounding the windings alters the properties of the insulation and can make the insulation conductive. Current flowing through insulation can destroy the insulation and hence the generator winding.

Conventional heaters or dehumidifying devices placed proximal to the generator can only heat or dehumidify the air inside the generator and not the winding itself where the problematic humidity is situated. The process is unreliable as a heater might raise the temperature of one portion of the generator but not portions where the winding could still be humid. Such devices are commonly engaged for long periods of time in an attempt to compensate for the aforementioned shortcomings.

### SUMMARY

The present disclosure relates to electric motors and generators, more specifically to an apparatus and method for dehumidifying the windings and insulation system of a motor or generator. Some embodiments may be implemented in conjunction with wind, water or other fluid turbines. The process is commonly performed prior to commissioning the machinery or after a period of time during which the machinery has been shut down.

In embodiments taught herein, a turbine converter is electrically coupled to a low voltage alternating current (AC) or direct current (DC) source, thereby providing systems and methods of generating low-voltage, low-frequency alternating current in the generator windings. Temperature rise of the winding system can be controlled by setting andr adjusting the amount of low-voltage, low-frequency current delivered. The appropriate amount of low-voltage, low frequency current to be delivered can vary. The application of AC low-voltage, low-frequency, high-current eliminates the effect of inductance and provides precise control of the energy losses that cause a rise of temperature in the winding. The controlled temperature increase occurs uniformly over the complete length of the winding, providing uniform dehumidification of the insulation system such that connection to the inverter and power production occurs without risk of damage to the insulation system. It will be apparent in view of this disclosure that additional embodiments may include the application of a low-voltage, high-frequency, high-current to said electrical machine windings for the aforementioned intended purpose. However, as explained in further detail below, the use of a semiconductor switching frequency lower than a semiconductor switching frequency used for normal converter operation results in a beneficial lowering of the risk of stressing of the insulation system during the heating cycle.

Various embodiments are directed to methods and systems, the systems comprising a combination generator and converter; a method comprised of utilizing the converter to dehumidify the generator before commissioning or after a dormant period.

### BRIEF DESCRIPTION OF THE DRAWINGS

The following is a brief description of the drawings, which are presented for the purposes of illustrating the disclosure set forth herein and not for the purposes of limiting the same.

FIG. 1 is a schematic diagram illustrating an example embodiment of a system for dehumidifying insulation in an electrical machine as taught herein.

FIG. 2 is a schematic diagram illustrating another example embodiment of a system for dehumidifying insulation in an electrical machine as taught herein.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the disclosed embodiment(s).

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

Electrical machinery operated by a converter incurs a high load on the winding insulation system due to high switching frequency, and high voltage, are also referred to as a high rate of voltage change over time (dv/dt levels). Engaging a converter as per its normal function is not an appropriate method for drying out a humid electrical machine as doing so incurs a risk of catastrophic damage to the insulation system. In particular, due to the reduced insulation capability of humid or wet insulation systems described above, the high switching frequency and voltage associated with operating load causes insulation breakdown which, in turn, exacerbates the reduced insulation capability, leading to destruction of the insulation and, ultimately, the windings.

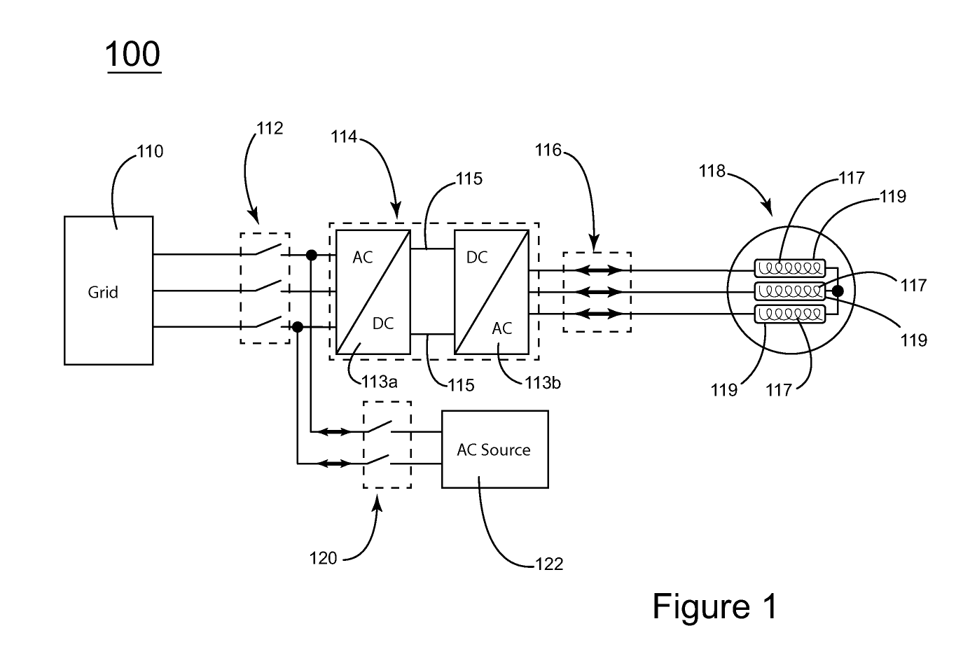

FIG. 1 is a schematic diagram of an exemplary system 100. FIG. 1 illustrates a electrical machine 118 such as, for example, a three-phase generator with star-connected windings 117 as shown. A converter 114 is electrically coupled to the three-phase electrical machine 118. The converter 114 is electrically coupled to the grid voltage system 110 through a three-phase, high-voltage switch 112 during normal operation. A low voltage AC supply 122 is electrically coupled to a low-voltage switch 120. Low-voltage, low-frequency, high alternating current is delivered to the converter when the low-voltage switch 120 is closed and the high-voltage switch 112 is open. Low-voltage, low-frequency, high alternating current 116 is delivered to the generator 118 prior to start-up of the generator. The low-voltage, low frequency, high alternating current 116 encounters ohmic resistance in the windings 117, thereby dissipating energy as heat evenly throughout the generator windings 117 via resistive heating and thus providing a system for evaporating moisture in the generator insulation system 119.

In accordance with various embodiments, the converter 114 can be, for example, a three-phase inverter/voltage source converter and can include an AC/DC inverter 113a in electrical communication with a DC link 115, which is also in electrical communication with a DC/AC inverter 113b, thereby allowing the system to control the voltage, frequency, and current level of the AC current delivered to the windings 117.

In accordance with various embodiments, the electrical machine 118 includes an insulation system 119 including an insulating material configured to create an electrical barrier from the current-carrying winding 117 to the magnetic system of the generator. Insulating materials of the insulating system can include, for example, mica, kapton epoxy, and/or any other suitable insulating material. Insulation 119 can insulate the windings 117 of the electrical machine 118.

In accordance with various embodiments, low voltage AC supply 122 can be any suitable supply, including for example, a low-voltage transformer and/or a secondary winding of a transformer.

Delivering low-voltage, low-frequency, high alternating current 116 to the windings 117 is advantageous for multiple reasons. High alternating current advantageously increases the resistive heating effect as compared to a low alternating current and can be, for example, between approximately 50%-100% of the rated generator current for the generator.

Additionally, for every switching of the voltage in the AC current, there is a capacitive charge current flowing in the insulation system 119 and a voltage overshoot. Each of these charges and overshoots stress the insulation system 119. When dry, the insulation system 119 is designed to withstand the charges and overshoots resulting from operational voltages and frequencies. However, in the wet state, the insulation system 119 cannot withstand those same operational conditions. Therefore, reducing voltage and frequency can advantageously reduce both the amplitude of the charges and overshoots and the overall number of charges and overshoots delivered to the insulation system 119 during dehumidification.

Low frequencies are further advantageous for reducing the impedance imposed on the current flow by the winding inductance. Accordingly, for example, in some embodiments, the frequency can be between approximately 0.01 Hz and 5 Hz (e.g., 0.2 Hz), although it will be understood in view of this disclosure that any suitable frequency can be used with various embodiments depending on the design capabilities of the insulation system. Furthermore, for example, in some embodiments, the voltage can advantageously be between approximately 1% and 10% (e.g., 2%) of a nominal voltage (e.g., line voltage, such as 120, 240 or 480 VAC), although it will be understood in view of this disclosure that any voltage low enough to avoid excessive stress on wet insulation but high enough to drive a desired current through the windings 117 can be used in accordance with various embodiments.

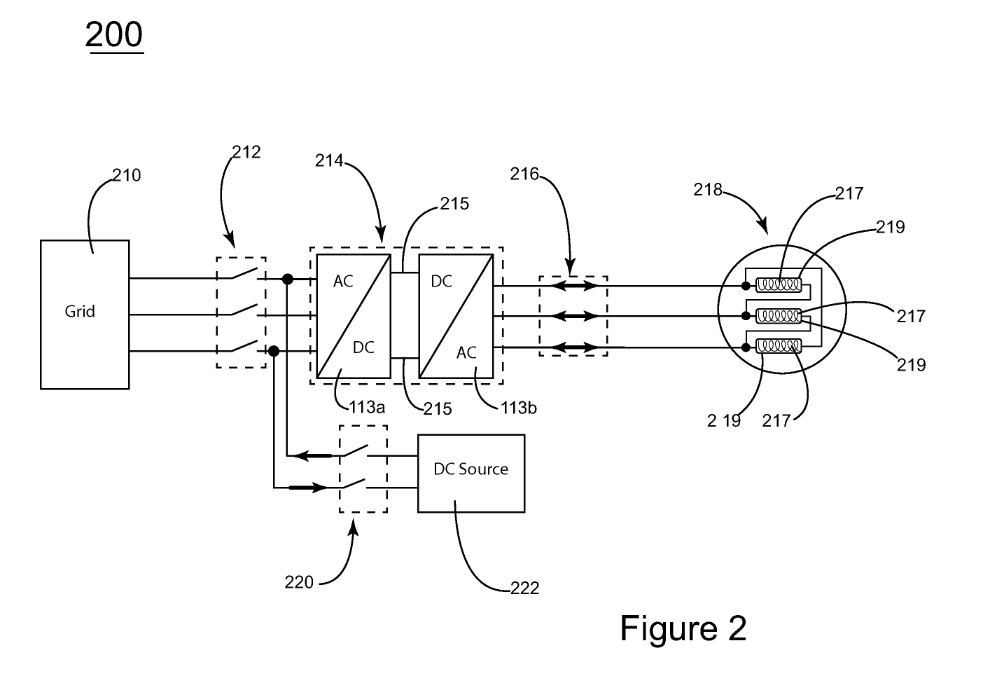

FIG. 2 is a schematic diagram of an exemplary system 200. FIG. 2 illustrates an electrical machine 218 such as, for example, a three-phase generator with delta-connected windings 217 as shown. It will be apparent in view of this disclosure that various electrical machines 218 may be affected by the systems and methods of the present embodiment. A converter 214 is electrically coupled to the three-phase electrical machine 218. The converter 214 is electrically coupled to the grid voltage system 210 through a three-phase, high-voltage switch 212 during normal operation. A low voltage DC supply 222 is electrically coupled to a low-voltage switch 220. Low-voltage, high direct current is delivered to the converter 214 when the low-voltage switch 220 is closed and the high-voltage switch 212 is open. The converter 214 then converts the low-voltage, high direct current into low-voltage, low-frequency, high alternating current 216, which is delivered to the generator 218 prior to start-up of the generator. The low-voltage, low frequency alternating current encounters ohmic resistance in the windings 217, thereby dissipating energy as heat evenly throughout the generator windings 217 via resistive heating and thus providing a means of evaporating moisture in the generator insulation system 219.

In accordance with various embodiments, converter 214 can be, for example, a three-phase inverter/voltage source converter and can include an AC/DC inverter 213a in electrical communication with a DC link 215, which is also in electrical communication with a DC/AC inverter 213b, thereby allowing the system to control the voltage, frequency, and current level of the AC current delivered to the windings 217 of the electrical machine 218. It will be apparent in view of this disclosure that the low-voltage, high direct current delivered to the converter 214 can be treated as AC current having a frequency of zero, thereby allowing the AC/DC inverter to receive the supplied low-voltage, high direct current from the low voltage DC supply 222.

In accordance with various embodiments, the insulation 219 includes an insulating material configured to create an electrical barrier from the current-carrying winding 217 to the magnetic system of the generator. Insulating materials of the insulation 219 can include, for example, mica, kapton epoxy, and/or any other suitable insulating material. Insulation 219 can insulate the winding 217 of the electrical machine 218

In accordance with various embodiments, low voltage DC supply 222 can be any suitable supply, including for example, a low-voltage transformer, a secondary winding of a transformer, and/or a switch mode DC power supply.

Delivering low-voltage, low-frequency, high alternating current 216 to the windings 217 is advantageous for multiple reasons. High alternating current advantageously increases the resistive heating effect as compared to a low alternating current and can be, for example, between approximately 50%-100% of the rated generator current for the generator.

Additionally, for every switching of the voltage in the AC current, there is a capacitive charge current flowing in the insulation system and a voltage overshoot. Each of these charges and overshoots stress the insulation system. When dry, the insulation system is designed to withstand the charges and overshoots resulting from operational voltages and frequencies. However, in the wet state, the insulation system cannot withstand those same operational conditions. Therefore, reducing voltage and frequency can advantageously reduce both the amplitude of the charges and overshoots and the overall number of charges and overshoots delivered to the insulation system during dehumidification.

Low frequencies are further advantageous for reducing the impedance imposed on the current flow by the winding inductance. Accordingly, for example, in some embodiments, the frequency can be between approximately 0.01 Hz and 5 Hz (e.g., 0.2 Hz), although it will be understood in view of this disclosure that any suitable frequency can be used with various embodiments depending on the design capabilities of the insulation system. Furthermore, for example, in some embodiments, the voltage can advantageously be between approximately 1% and 10% (e.g., 2%) of a nominal voltage (e.g., line voltage, such as 120, 240 or 480 VAC), although it will be understood in view of this disclosure that any voltage low enough to avoid excessive stress on wet insulation but high enough to drive a desired current through the windings 217 can be used in accordance with various embodiments.

The present disclosure has been described with reference to exemplary embodiments. Modifications and alterations may occur to others upon reading and understanding the preceding detailed description. It is intended that the present disclosure be construed as including all such modifications and alterations insofar as they come within the scope of the appended claims or the equivalents thereof.

1) A system for dehumidifying insulation in an electrical machine, the system comprising:
a converter having an output circuit in electrical communication with the electrical machine and an input circuit switchably coupled to each of a first power source and a second power source, the first power source including a power grid, the second power source including a low-voltage, low-frequency power source, the output circuit of the converter being configured to deliver low-voltage, low-frequency energy from the second power source to the electrical machine while the converter is coupled to the second power source and decoupled from the first power source,
wherein the low-voltage, low-frequency energy dissipates as heat in a winding of the electrical machine, and
wherein the heat provides for the evaporation of moisture from insulation in the electrical machine.

2) The system of claim 1, wherein the low-voltage, low-frequency energy includes a voltage in a range of between approximately 1% and 10% of a nominal voltage and a frequency between approximately 0.01 Hz and 5 Hz.

3) The system of claim 1, wherein the second power source includes a low-voltage, low-frequency, high alternating current power source.

4) The system of claim 3, the low-voltage, low-frequency, high alternating current having a current between 50% and 100% of a rated generator current of the electrical machine.

5) The system of claim 1, wherein the converter is a three-phase inverter/voltage source converter.

6) The system of claim 5, wherein the three-phase inverter/voltage source converter comprises:
an AC/DC inverter;
a DC link in electrical communication with the AC/DC inverter; and
a DC/AC inverter in electrical communication with the DC link.

7) A method of dehumidifying insulation in an electrical machine, the method comprising:
receiving, at a converter switchably coupled to each of a first power source and a second power source, an input waveform from the second power source, the second power source including a low-voltage, low-frequency power source;
converting the input waveform to a low-voltage, low-frequency output waveform; and
driving electromagnetic energy with the output waveform to dissipate as heat in a winding of the electrical machine,
wherein the heat provides for the evaporation of moisture from insulation in the electrical machine.

8) The method of claim 7, wherein the low-voltage, low-frequency energy includes a voltage in a range of between approximately 1% and 10% of a nominal voltage and a frequency between approximately 0.01 Hz and 5 Hz.

9) The method of claim 7, wherein the second power source includes a low-voltage, low-frequency, high alternating current power source.

10) The method of claim 9, the low-voltage, low-frequency, high alternating current having a current between 50% and 100% of a rated generator current of the electrical machine.

11) The method of claim 7, wherein the converter is a three-phase inverter/voltage source converter.

12) The method of claim 11, wherein the three-phase inverter/voltage source converter comprises:
an AC/DC inverter;
a DC link in electrical communication with the AC/DC inverter; and
a DC/AC inverter in electrical communication with the DC link.

13) A system for dehumidifying insulation in an electrical machine, the system comprising:
a converter having an output circuit in electrical communication with the electrical machine and an input circuit switchably coupled to each of a first power source and a second power source, the first power source including a power grid, and the second power source including a low-voltage, direct current power source, the converter being configured to convert low-voltage, direct current energy received from the second power source to low-voltage, low frequency alternating current energy, the output circuit of the converter being configured to deliver the low-voltage, low-frequency alternating current energy to the electrical machine while the converter is coupled to the second power source and decoupled from the first power source,
wherein the low-voltage, low-frequency alternating current energy dissipates as heat in a winding of the electrical machine, and
wherein the heat provides for the evaporation of moisture from insulation in the electrical machine.

14) The system of claim 13, wherein the low-voltage, direct current energy includes a voltage in a range of between approximately 1% and 10% of a nominal voltage.

15) The system of claim 13, the low-voltage, low-frequency, alternating current having a current between 50% and 100% of a rated generator current of the electrical machine.

16) The system of claim 13, wherein the converter is a three-phase inverter/voltage source converter comprising:
an AC/DC inverter;
a DC link in electrical communication with the AC/DC inverter; and
a DC/AC inverter in electrical communication with the DC link.

17) A method of dehumidifying insulation in an electrical machine, the method comprising:
receiving, at a converter switchably coupled to each of a first power source and a second power source, an input waveform from the second power source, the second power source including a low-voltage, direct current power source;
converting the input waveform to a low-voltage, low-frequency alternating current output waveform; and
driving electromagnetic energy with the output waveform to dissipate as heat in a winding of the electrical machine,
wherein the heat provides for the evaporation of moisture from insulation in the electrical machine.

18) The method of claim 17, wherein the low-voltage, direct current energy includes a voltage in a range of between approximately 1% and 10% of a nominal voltage.

19) The method of claim 17, the low-voltage, low-frequency, alternating current having a current between 50% and 100% of a rated generator current of the electrical machine.

20) The system of claim 13, wherein the converter is a three-phase inverter/voltage source converter comprising:
an AC/DC inverter;
a DC link in electrical communication with the AC/DC inverter; and
a DC/AC inverter in electrical communication with the DC link.
